(19) United States
(12) Patent Application Publication
(10) Pub. No.: US 2005/0210462 A1
(43) Pub. Date: Sep. 22, 2005

(54) Systems and method for the incremental deployment of Enterprise Java Beans

(75) Inventors: Kenneth A. Chupa, Guelph (CA); Sridhar Sudarsan, Austin, TX (US)

Correspondence Address: Barry S. Newberger, P.O. Box 50784, Dallas, TX, 75201, US

(73) Assignee: International Business Machines Corporation, Armonk, NY (US)

(21) Appl. No.: 10/798,936

(22) Filed: Mar. 11, 2004

(51) Int. Cl. G06F 9/44

(52) U.S. Cl. 717/171

(57) ABSTRACT

Systems and methods for selectively deploying enterprise software are provided. For each deployable software component (exemplified by, but not limited to Enterprise JavaBeans, or “EJB”s) in an preselected input archive file, interfaces of deployable software components identified in a first and second descriptor file in, respectively, the preselected input archive file and a preselected output archive file are compared. If tan interface miscompares for a first deployable software component, the first deployable software component is tagged. Additionally, if an interface miscompares for a second deployable software the second deployable software component is also tagged. Each tagged deployable software component is deployed.

### TECHNICAL FIELD

The present invention relates to data processing systems, particularly data processing systems for distributed applications, and more particularly such data processing systems in which a component architecture for building scalable, secure and multi-platform applications, particularly Enterprise JavaBeans (EJBs).

### BACKGROUND INFORMATION

The trend in modern business data processing system services is the delivery of business applications to users via distributed software applications. In this way a business enterprise may advantageously exploit the economies of scale represented by the increasing capability of modern data processing hardware without having to incur large capital outlays that would otherwise be incurred if the data processing services were not outsourced. This, however, requires service providers to create and deploy sophisticated application software in a distributed data processing environment. Additionally, the software must be reliable.

A component architecture model that has been developed to address the complexities associated with such sophisticated distributed business applications is the Enterprise JavaBeans (EJB) architecture. Generically, a Java bean is simply a reusable software component which can be manipulated visually in a builder tool. EJBs form a particular category of such Java beans. Java-bean-like component in a distributed environment may generically be referred to as a deployable software component, or for simplicity a “Bean.” A deployment methodology in accordance with the present inventive principles will be described below. The EJB architecture is a server-side component model to the Java platform. The EJB architecture isolates the development of the application, that is, the programming logic that performs a function or task, from the infrastructure used to support distributed data processing services, particularly distributed applications over a network such as the Internet.

FIG. 1 depicts an illustrative EJB architecture 100. EJB server 102 provides a collection of services that support an EJB installation. These services may include management of distributed transactions, management of distributed objects and distributed invocations on these objects, as well as low-level system services. In short, EJB server 102 manages resources that support EJB components. In this way, as previously mentioned, the EJB architecture 100 isolates the application logic from infrastructure supporting the distributed data processing services. EJB servers may be provided by proprietary software vendors. Alternatively, an open source EJB server is the JBOSS™ implementation promulgated under the auspices of the JBoss Group, LLC, Atlanta, Ga. Bean components (or simply Beans) 104a-104c implement the application services that are provided by a distributed data processing system using an EJB model. An EJB 104a-104c includes Java class files constituting the Java executable code that perform the operations that make up the services provided by the data processing system.

EJBs 104a-104c include a remote interface specified by the programmer. Recall that interfaces in Java are a type of abstract class. The remote interface defines the method signatures and return types of the methods that handle the remote object invocations from a client. However, the Beans themselves, such as Beans 104a-104c do not implement the remote interface. Corresponding Bean containers 106a-106c implement the respective remote interfaces, depicted as Bean objects 108a-108c. The implementation of a remote interface is commonly referred to as a “skeleton.” Bean objects 108a-108c intercept remote object invocations from a client such as client 110. The Bean objects then invoke the corresponding methods in its respective Bean implementation 104a-104c. In turn, the methods of the EJB 104a-104c may access other system resources 112, such as a database, for example, to provide the requested service to the client.

Additionally, EJB containers 106a-106b also implement a respective EJB home interface also defined in the respective one of Beans 104a-104c. EJB homes 114a-114c expose the methods of the corresponding Bean home interface to client 112. The methods of the EJB home interface may provide for the creation of an EJB instance, deletion of an EJB instance, or metadata about the respective EJB. EJB containers also provide a runtime environment for a EJB. Note that the container, such as containers 106a-106c may be built by EJB server 100 when the EJBs are deployed. In other words, the programming of the container is generated by the EJB server 102, not by the programmer writing the EJB itself.

The containers are built during the deployment of the EJB, such as EJB 104a-104c in FIG. 1. Deployment may be effected by deployer 116. A deployer methodology that may be used in conjunction with deployer 116 will be described further hereinbelow. In general, however, deployer 116 receives Java class files (generated by compiling Java source code, as would be appreciated by those of ordinary skill in the art), and builds stub and skeleton classes, for example, by running the rmic stub compiler, a component of the Java Development Kit (JDK). These are passed to the bean server such as Bean server 102, wherein the skeleton class files, when deployed, becomes the Bean object for the Bean(s) being deployed.

A typical distributed application may include many EJBs. These are packaged in Java ARchive (“JAR”, or “.jar”) files (as would be appreciated by persons of ordinary skill in the art, .jar files comprise a set of class files combined into a single archive stored in ZIP file format). The EJB class files may also be packaged in Enterprise Archive (“.ear”) files and Web Archive (“.war”) files. Typically, a .ear file may include one or more .jar and .war files. All of these types of archive files are, for the purposes herein, equivalent to .jar files and for simplicity of notation the terminology JAR or .jar will be used throughout. However, those persons of ordinary skill in the relevant art would appreciate that the description would equally apply to .jar, .ear and .war files. When an application is deployed, as described above, the operations including generating the stub and skeleton class files are repeated for each EJB in the jar file containing the modified Bean. If a Bean is modified, particularly with respect to the interfaces, the Bean may need to be redeployed. However, this necessitates redeploying all of the Beans in the .jar file containing the modified Bean. For a typical application which may have a significant number of EJBs, the redeployment can be both time consuming and system resource intensive as all of the deployed code is generated.

Consequently, there is a need in the art for systems and methods for selectively deploying EJBs as needed. In particular, systems and methods which provide for selective deployment of EJBs without user intervention are desirable.

### SUMMARY OF THE INVENTION

The aforementioned needs are addressed by the present invention. Accordingly, there is provided a method for selectively deploying enterprise software. For each deployable software component (exemplified by, but not necessarily limited to Enterprise JavaBeans, or “EJB”s) in an preselected input archive file, interfaces of deployable software components identified in a first and second descriptor file in, respectively, the preselected input archive file and a preselected output archive file are compared. If an interface miscompares for a first deployable software component, the first deployable software component is tagged. Additionally, if an interface miscompares for a second deployable software the second deployable software component is also tagged. Each tagged deployable software component is deployed.

The foregoing has outlined rather broadly the features and technical advantages of the present invention in order that the detailed description of the invention that follows may be better understood. Additional features and advantages of the invention will be described: hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an EnterpriseJavaBean architecture in accordance with the present inventive principles;

FIG. 2 illustrates, in flowchart form, a methodology for selectively deploying Enterprise JavaBeans in accordance with the embodiment of the present invention; and

FIG. 3 illustrates, in block diagram form, a data processing system that may be used to perform the process of FIG. 2.

### DETAILED DESCRIPTION

In the following description, numerous specific details are set forth to provide a thorough understanding of the present invention. For example, particular attributes or file types may be used to illustrate the present inventive principles. However, it will be apparent to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

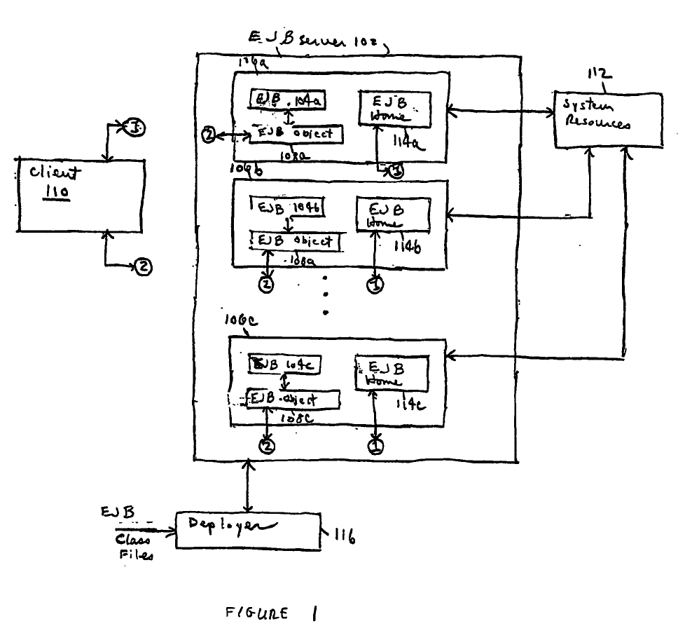

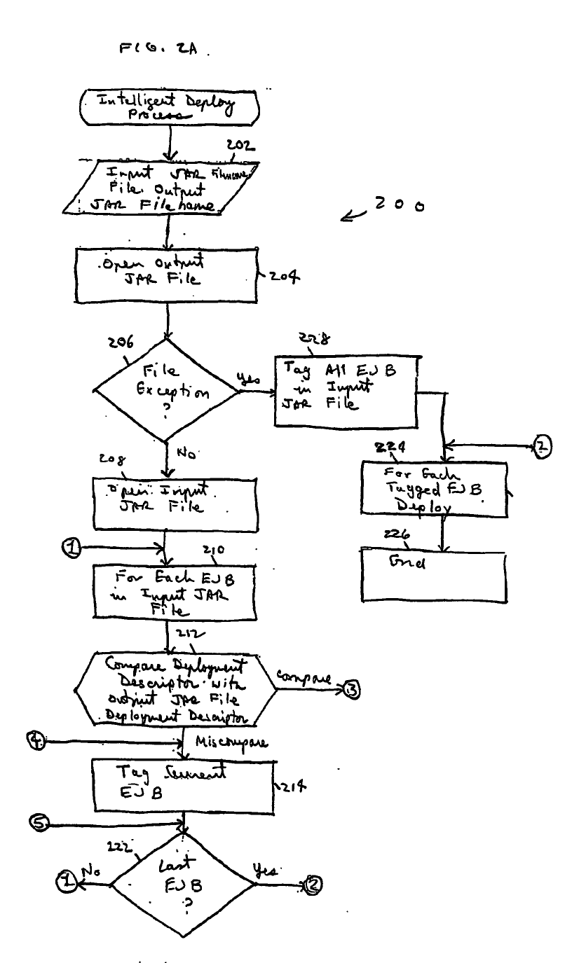

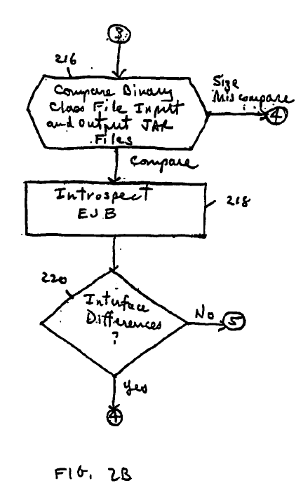

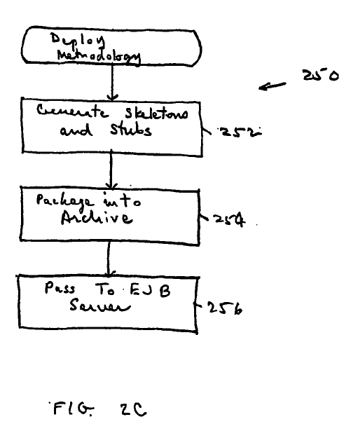

Referring to FIG. 2, a methodology 200 for selectively deploying Enterprise JavaBeans (EJBs) in accordance with an embodiment of the present invention is illustrated. Methodology 200 may be performed by deployer 116, FIG. 1. In step 202, the input JAR filename and an output JAR filename are received as input parameters to methodology 200. For ease of description, these filenames will be referred to hereinbelow as in_file.jar and out_file.jar, respectively. Plainly, these are exemplary names, and in general may be arbitrary, although the .jar (or .ear, .war) extension is conventional. The output JAR file represents the name of the JAR file to be deployed, which, however, may be the archive file for a preexisting application. The file names may be input by a programmer, commonly referred to as an Assembler, responsible for deploying a set of EJBs on an EJB server, such as Bean Server 102, FIG. 1. Note that methodology 200 may be invoked in response to a build tool. Such tools are commonly used by programmers to automate a software build under the control of a build script to alleviate the need for the manual execution of repetitive tasks. One such build tool is Ant™, a Java-based build tool promulgated by the Apache Software Foundation. The input and output JAR file names may be passed to methodology 200 in step 202 via the build script. In step 204, the output JAR file, out_file .jar, is opened.

If the file out_file .jar does not exist, a file exception will be thrown. In step 206, it is determined if there is such a file exception, indicating that the output file does not exist. If the output file is opened successfully, no exception is thrown, and step 206 proceeds by the “No” branch and in step 208, the input JAR file in_file .jar, is opened.

In step 210, a loop iterating over each of the EJBs in the input JAR file is entered. This loop iterates over each of the EJBs in the input JAR file, in_file .jar. In step 212, the deployment descriptor data for the current Bean in the iteration loop is compared with the corresponding data in the deployment descriptor contained in the output JAR file, out_file .jar, and opened in step 204. A deployment descriptor is a file included in each JAR file for an EJB application. The deployment descriptor is generated by the programmer writing the application and is an XML document. (A person of ordinary skill in the relevant art would appreciate that XML is the eXtensible Markup Language; a tag-based markup language for describing structured data.) The deployment descriptor tells the EJB Server which classes make up the Bean implementation, the home interface, remote interface and local interface (if a local interface exists). For example, in step 212, the interfaces for the current EJB in the input and output JAR files are compared if one or more of these miscompare, in step 214, the current Bean is tagged. An EJB Bean may be “tagged” by inserting its name into a list of changed Beans which may be temporarily generated. Other comparisons may also be made. The document descriptor contains attributes associated with the EJB. For example, an attribute specifying a persistence mechanism for managing the EJB's persistent data may be included. Such mechanisms may be employed in a database management application, for example. Another attribute example, also pertinent to database management applications might be the primary key value. If EJBs have been added to the input JAR file subsequent to the deployment of the named output JAR file, the new EJBs will also trigger a miscompare because the deployment descriptor in the named input JAR file will contain data with respect to the new Beans not found in the named output JAR file.

Considering again step 212, if the deployment descriptors compare with respect to the interfaces for the current EJB, process 200 proceeds to step 216. In step 216, the size of the binary class files for the current Bean in the input and output JAR files are compared. Comparison of the binary files avoids triggering on changes on the whitespace or other formatting that might otherwise occur if source code files are compared. If, the interfaces miscompare, process 200 proceeds to step 214 and tags the current EJB, as previously described. If, for example, the signature on a method has changed, but the transaction attributes are not mentioned in the deployment descriptor, the descriptor comparison in step 212 would be satisfied. That is, the deployment descriptors would be the same, and step 212 would fall through the “compare” branch. However, the class size may, nevertheless, be different, in which case step 216 would miscompare.

Conversely, if, in step 216, the size of the binary class files in the input and output JAR files compare, an introspection on the EJB is performed in step 218. Introspection is based on the Java reflection mechanism for obtaining information about the members of a class. Java includes a reflection package that allows a program to inspect the members of a class including returning the signatures and return types of the methods of the class that are declared public. The reflection package may be used to return such information with respect to the current EJB in each of the input and output JAR files. In step 220, it is determined if differences appear in the methods of the interfaces for the current EJB in each of the input and output JAR files. Considering again the example, in which a signature on a method has changed and the transaction attributes are not mentioned in the deployment descriptor, the class size may, but need not, change. In that circumstance, step 216 will also fall through the “compare” branch. However, steps 218 and 220 will effect the detection of the difference in the interface and thus the deployment of the modified EJB via step 214. If there are differences, the Bean is tagged in step 214. Otherwise, step 214 is bypassed, and in step 222 it is determined if the current EJB is the last EJB. If not, process 200 returns to step 210 to continue through the loop over the EJB in the input JAR file.

Conversely, if, in step 222, the current EJB is the last EJB in the JAR file, process 200 continues, in step 224, and for each tagged EJB deploys the EJB. A methodology for deploying EJB will be described in conjunction with FIG. 2C hereinbelow.

Returning to step 206, if in opening the output JAR file, in step 204, named in step 202, a file exception is thrown, then in step 228 all the EJBs in the input JAR file are tagged. Process 200 then deploys the EJBs in step 224. In this way, process 200 may be used transparently to initially deploy an EJB or EJBs. Process 200 terminates in step 226.

Refer now to FIG. 2C illustrating in further detail a deploy methodology 250 that may be used in performing step 218 in FIG. 2B. In step 252, the skeletons and stubs for the Beans being deployed are generated. As previously discussed, skeletons implement the interfaces defined for the EJB. A stub is a proxy for the EJB on the client side. The skeleton and stub class files may be generated by the Java RMI stub compiler, rmic. The rmic compiler is a part of the Java Development Kit (JDK). In step 254, the skeleton and stub class files generated in step 252 are packaged into the output JAR file. This may be effected using the j ar tool that is also part of the JDK. In step 256, the output JAR file is passed to the Bean server, such as Bean server 102, FIG. 1.

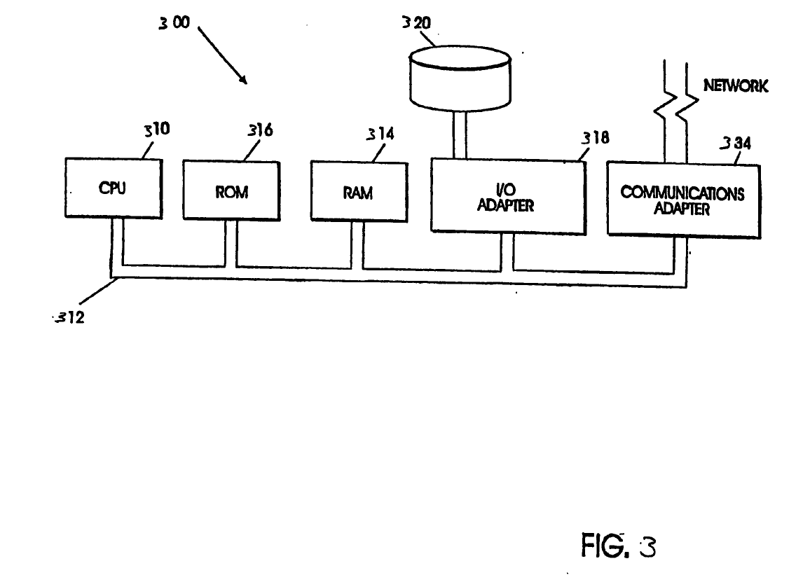

FIG. 3 illustrates an exemplary hardware configuration of data processing system 300 in accordance with the subject invention. The system in conjunction with the methodologies illustrated in FIGS. 2A-2C may be used selectively deploy Enterprise JavaBeans (EJBs) in accordance with the present inventive principles. Data processing system 300 includes central processing unit (CPU) 310, such as a conventional microprocessor, and a number of other units interconnected via system bus 312. Data processing system 300 also includes random access memory (RAM) 314, read only memory (ROM) 316 and input/output (I/O) adapter 318 for connecting peripheral devices such as nonvolatile storage units 320 to bus 312. System 300 also includes communication adapter 334 for connecting data processing system 300 to a data processing network, enabling the system to communicate with other systems. CPU 310 may include other circuitry not shown herein, which will include circuitry commonly found within a microprocessor, e.g. execution units, bus interface units, arithmetic logic units, etc. CPU 310 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 314 of one or more computer systems configured generally as described above. These sets of instructions, in conjunction with system components that execute them selectively deploy EJBs as described hereinabove. Until required by the computer system, the set of instructions may be stored as a computer program product in another computer memory, for example, in nonvolatile storage unit 320 (which may include a removable memory such as an optical disk, floppy disk, CD-ROM, or flash memory for eventual use in nonvolatile storage unit 320). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

1. A method for selectively deploying enterprise software comprising:
for each deployable software component in an preselected input archive file, comparing interfaces for the deployable software component identified in a first descriptor file in said input archive file and a second descriptor file in a preselected output archive file;
if the comparing step miscompares for a first deployable software component, tagging said first deployable software component;
if the comparing step miscompares for a second deployable software component, tagging said second deployable software component; and
deploying each tagged deployable software component.

2. The method of claim 1 wherein tagging a deployable software component comprises storing a name of the deployable software component in a file.

3. The method of claim 1 further comprising:
if the first descriptor file and second descriptor file compare for the first deployable software component, comparing a size of a binary class file for the first deployable software component in the input and output archive files; and
if the size of said binary class files miscompare, tagging the first deployable software component.

4. The method of claim 1 further comprising:
if the first descriptor file and second descriptor file compare for the first deployable software component, introspecting a binary class file for the first deployable software component in the input and output archive files; and
if, in response to the introspection, a signature or return type of an interface of said binary class files miscompare, tagging the first deployable software component.

5. The method of claim 1 further comprising:
opening said preselected output archive file; and
if the step of opening the preselected output archive fails, tagging each deployable software component in the input archive file.

6. The method of claim 5 wherein the step of tagging each deployable software component is performed in response to the step of opening the preselected output archive throwing an exception.

7. The method of claim 1 wherein the comparing, tagging and deploying steps are performed in response to an execution of a build script invoking a selective deployer utility.

8. A computer program product embodied in a machine-readable medium for selectively deploying enterprise software, the program product comprising programming instructions for:
for each deployable software component in an preselected input archive file, comparing interfaces for the deployable software component identified in a first descriptor file in said input archive file and a second descriptor file in a preselected output archive file;
if the comparing operation miscompares for a first deployable software component, tagging said first deployable software component;
if the comparing operation miscompares for a second deployable software component, tagging said second deployable software component; and
deploying each tagged deployable software component.

9. The program product of claim 8 wherein tagging a deployable software component comprises storing a name of the deployable software component in a file.

10. The program product of claim 8 further comprising programming instructions for:
if the first descriptor file and second descriptor file compare for the first deployable software component, comparing a size of a binary class file for the first deployable software component in the input and output archive files; and
if the size of said binary class files miscompare, tagging the first deployable software component.

11. The program product of claim 8 further comprising programming instructions for:
if the first descriptor file and second descriptor file compare for the first deployable software component, introspecting a binary class file for the first deployable software component in the input and output archive files; and
if, in response to the introspection, a signature or return type of an interface of said binary class files miscompare, tagging the first deployable software component.

12. The program product of claim 8 further comprising programming instructions for:
opening said preselected output archive file; and
if the operation of opening the preselected output archive fails, tagging each deployable software component in the input archive file.

13. The program product of claim 12 wherein the operation of tagging each deployable software component is performed in response to the operation of opening the preselected output archive throwing an exception.

14. The program product of claim 8 wherein the comparing, tagging and deploying operations are performed in response to an execution of a build script invoking a selective deployer utility.

15. A data processing system for selectively deploying enterprise software comprising:
circuitry operable for, for each deployable software component in an preselected input archive file, comparing interfaces for the deployable software component identified in a first descriptor file in said input archive file and a second descriptor file in a preselected output archive file;
circuitry operable for, if the comparing operation miscompares for a first deployable software component, tagging said first deployable software component;
circuitry operable for, if the comparing operation miscompares for a second deployable software component, tagging said second deployable software component; and
circuitry operable for deploying each tagged deployable software component.

16. The data processing system of claim 15 wherein tagging a deployable software component comprises storing a name of the deployable software component in a file.

17. The data processing system of claim 15 further comprising:
circuitry operable for, if the first descriptor file and second descriptor file compare for the first deployable software component, comparing a size of a binary class file for the first deployable software component in the input and output archive files; and
circuitry operable for, if the size of said binary class files miscompare, tagging the first deployable software component.

18. The data processing system of claim 15 further comprising programming instructions for:
circuitry operable for, if the first descriptor file and second descriptor file compare for the first deployable software component, introspecting a binary class file for the first deployable software component in the input and output archive files; and
circuitry operable for, if, in response to the introspection, a signature or return type of an interface of said binary class files miscompare, tagging the first deployable software component.

19. The data processing system of claim 15 further comprising
circuitry operable for opening said preselected output archive file; and
circuitry operable for, if the operation of opening the preselected output archive fails, tagging each deployable software component in the input archive file.

20. The data processing system of claim 19 wherein the operation of tagging each deployable software component is performed in response to the operation of opening the preselected output archive throwing an exception.
